(19) United States
(12) Patent Application Publication
(10) Pub. No.: US 2026/0358057 A1
(43) Pub. Date: Nov. 12, 2026

(54) HOT REPAIR METHOD

(71) Applicant: SAINT-GOBAIN CENTRE DE RECHERCHE ET D'ETUDES EUROPEEN, COURBEVOIE (FR)

(72) Inventors: Thibault CHAMPION, VILLELAURE (FR); Franceline Marguerite VILLERMAUX, AVIGNON (FR); Christian HIS, CAVAILLON (FR)

(21) Appl. No.: 19/131,771

(22) PCT Filed: Nov. 30, 2023
(86) PCT No.: PCT/EP2023/083663

§ 371 Date: May 21, 2025

(30) Foreign Application Priority Data
Nov. 30, 2022 (FR) FR2212561

(51) Int. Cl. F27D 1/16; C21C 5/44

(52) U.S. Cl. CPC F27D 1/16; C21C 5/441; F27D 2001/161

(57) ABSTRACT

A method is provided for hot repairing a region to be repaired inside an industrial plant other than a glass furnace, the region to be repaired being at a temperature above 250 °C. The method includes installing an inner formwork in a service position, so as to prepare a mould around the region to be repaired; and filling the mould with a repair product, where at least a portion of the inner formwork is made of a ceramic matrix composite.

### TECHNICAL FIELD

The present invention relates to a process for the hot repair of an industrial facility, in particular an industrial facility other than a glassmaking furnace.

### PRIOR ART

An industrial facility subject to high temperatures conventionally includes parts made of a refractory product, chosen as a function of the location in which they are arranged, so as to withstand local stresses, notably chemical and/or thermal aggression associated with the operation of said industrial facility, and to afford it a satisfactory service life. The choice may also be guided by the need to avoid generating faults during operation of the industrial facility, in particular when the latter is a steel melting furnace. For example, in a steel-smelting induction furnace, it is important to avoid introducing phosphorus, which embrittles the steel.

In order to extend the service life of an industrial facility, in particular an industrial furnace, the operator must perform repairs. A repair consists in filling an empty space resulting from wear of the industrial facility with a repair product, i.e. attaching a repair product to a region initially occupied by a refractory material and which has disappeared due to wear. This region is referred to as the “region to be repaired”.

FIG. 1 represents a region of an industrial facility 10 as it was before wear (left), and after wear (right). As illustrated in this figure, a region to be repaired 30, may be “recessed”, i.e. in the form of a cavity 301, for example in a bottom wall 24. It may also be “protruding”, i.e. being a region 302 in the extension of an initially protruding block. The region to be repaired may also pass through the wall of a chamber, for example the side wall of a tank 31, placing the inside and outside of the chamber in fluid communication. Such a traversing region to be repaired may in particular lead to leaks, notably of gas or product, in particular molten product. Such leaks are hazardous and may lead to shutdowns. The region to be repaired 303 is an example of a traversing repair region created in a side wall 22.

A region to be repaired is an empty space, i.e. free of refractory material, partially delimited by one or more refractory parts of the industrial facility.

To repair an industrial facility, in particular an industrial furnace, a formwork is conventionally made so as to materialize the region to be repaired and, optionally with the refractory part(s), to make a mold that is capable of retaining the repair product before it hardens. The elements of the formwork, for example in the form of plates, which may or may not be flat, are conventionally held by accessories in a working position in which they define said mold.

The formwork includes or consists of a part arranged on the side in which the wear initially occurred. This part of the formwork is referred to as the “inner formwork”. For example, to repair the wall of a furnace chamber formed of refractory blocks, an inner formwork is arranged to delimit the region to be repaired inside the chamber.

When wear has resulted in a passage through the wall, the formwork may also include a part outside the chamber, or “outer formwork”, so as to prevent the repair product from escaping outside the chamber. The outer part of the formwork is conventionally a veneer.

A “hot” repair is one that is performed at a temperature typically in excess of 250 °C. Hot repair therefore requires only a limited reduction in temperature, or even no reduction at all, which considerably reduces or even eliminates the downtime of the industrial facility.

Moreover, the region to be repaired, in particular inside a closed chamber, is often sparingly accessible, which makes it difficult to produce the inner formwork for certain regions to be repaired. In particular, the introduction of the inner formwork elements may require passages through the chamber wall. In addition, during hot repair, sometimes no operator is able to enter the chamber. The inner formwork installation operation must therefore be performed at a distance from the region to be repaired. The size and weight of the inner formwork elements may thus considerably slow down the production of the formwork.

These constraints also make it very difficult to produce complex inner formworks, in particular when the region to be repaired protrudes into the chamber.

The mold is then filled with the repair product, conventionally by means of a pump. The temperature of the repair product rises sharply as it enters the mold, notably reducing its flowability. It is thus difficult to fill the mold homogeneously.

Conventionally, the inner formwork is made of metal and is cooled by circulating water. Once the repair product has hardened, the inner formwork is removed.

Once the repair product has hardened, the formwork is removed, leaving room for reconstituted refractory parts. Generally speaking, however, metal formworks do not allow the original shapes to be reconstituted if they are complex.

There is also a hot repair solution consisting in spraying (gunning) a repair product into the region to be repaired. However, this repair technique does not allow repairs of significant thickness to be performed.

There is thus an ongoing need for a repair process which solves the abovementioned problems, and which in particular allows the industrial facility to be put back into production quickly.

The present invention is directed toward satisfying this need, at least in part.

### SUMMARY OF THE INVENTION

The invention proposes a process for the hot repair of a region of an industrial facility at a temperature above 250 °C, in particular inside a chamber of the industrial facility, in particular inside a chamber of an industrial furnace, known as the “region to be repaired”, the industrial facility preferably being other than a glassmaking furnace, said process including the following steps:
a) installing a formwork in a working position, so as to make a mold around the region to be repaired;
b) filling, preferably by casting, the mold with a repair product, at least a portion of the formwork being made of a Ceramic Matrix Composite (CMC).

As will be seen in greater detail later in the description, the inventors have notably discovered that a CMC does not substantially modify the quality of the product manufactured in said facility when placed in contact with said product, and/or does not substantially modify the performance of said industrial facility, and thus does not require removal of the formwork at the end of the repair.

Moreover, a CMC
is lightweight, making it easy to handle,
is readily conformable to complex geometries, allowing precise adaptation to the configuration of the region to be repaired.

In addition, a CMC is highly resistant to thermal shock, in particular allowing hot repair without damaging the formwork elements when they are introduced into a chamber of the industrial facility.

The invention thus allows a particularly rapid return to production of the industrial facility.

A process according to the invention may even include one or more of the following optional and preferred features:
the industrial facility is chosen from:
   an iron or steel smelting furnace, and a part of such a furnace;
   a furnace for melting non-ferrous metals;
   an element configured to transfer molten metal, in particular from a furnace for melting said metal, said element possibly being physically disengaged from said furnace;
   a cement plant furnace;
   an ore reduction furnace;
   an incinerator;
   a hazardous waste treatment furnace;
   a gasifier;
   a reformer;
   a ceramic firing furnace;
   a carbon black reactor;
   a holding tank intended to contain a molten product at a temperature in excess of 250 °C, notably in the event of accidental spillage of said product;
   an aluminum electrolysis cell;
   a turbine combustion chamber;
   a boiler;
the process includes, after step b), a step 5) of sintering the repair product introduced into the mold in step b), the sintered repair product obtained consisting of a plurality of constituents, the mass content of any constituent of the sintered repair product present in a mass content greater than 5%,
   differing by less than 20% from the mass content of said constituent in said ceramic matrix composite, and/or
   differing by less than 20% from the mass content of said constituent in a region of the industrial facility delimiting the region to be repaired;
at least one element of said formwork has the shape of a part of the industrial facility which was protruding before said part disappeared as a result of wear;
the manufacture of the formwork involves taking an imprint on an at least partial replica of said industrial facility as it was before the wear which led to the generation of the region to be repaired;
the formwork is abandoned in the region to be repaired after said repair;
the formwork is made entirely of a ceramic matrix composite;
at least one element of the formwork made of a ceramic matrix composite includes through holes and/or recesses arranged so as to be filled by the repair product during step b);
preferably, the mass of a formwork element, preferably the mass of more than 50% in number of the formwork elements, preferably the mass of each of the formwork elements, is greater than 3 kg, preferably greater than 4 kg and/or preferably less than 50 kg, preferably less than 40 kg, preferably less than 30 kg, preferably less than 20 kg;
preferably, the largest dimension of a formwork element, preferably more than 30% in number of the formwork elements, preferably more than 50% in number of the formwork elements, is greater than 400 mm, preferably greater than 600 mm and preferably less than 1600 mm, preferably less than 1400 mm;
the formwork includes
   formwork elements partially delimiting the region to be repaired, and
   accessories for holding said formwork elements in a working position,

said accessories being made of a ceramic matrix composite, identical to or different from the ceramic matrix composite of the formwork elements;
the ceramic matrix composite of at least part of the formwork, or even of the entire formwork, and/or the ceramic matrix composite of at least one accessory
   is (are) sintered, and/or
   has/have an open porosity greater than 15% and less than 50%, and/or
   includes(s) more than 20% and less than 80% by volume of fibers, and/or
   include(s) fibers of which at least a portion are fibers including more than 95% by mass of oxides, and/or
   includes(s) fibers of which at least a portion are fibers including more than 95% by mass of a material other than an oxide, and/or
   includes(s) a matrix made up of more than 90% oxides and/or carbides and/or nitrides and/or at least one oxynitride compound of at least the elements Si, Al and N, in particular a sialon, in mass percentages, and/or
   have a bulk density of greater than 1.0 g/cm³ and less than 2 g/cm³;
said process includes the following steps:
   2) optionally, rinsing said region to be repaired,
   3) optionally, reducing the temperature in said industrial facility to a temperature above 250 °C;
   4) performing steps a) and b);
   5) preferably, in particular when the process includes a step 3), increasing and maintaining the temperature of the industrial facility between 400 °C and 1400 °C so as to sinter the repair product;
   6) if said process includes a step 3), raising the temperature of said industrial facility to its operating temperature;
the industrial facility includes a chamber containing a fluid product, preferably a powdered or molten product, in particular a molten metal, and said process includes, prior to step a), the following step:
   if the region to be repaired is, at least partially, delimited by a surface of the industrial facility in contact with said fluid product, at least partial emptying of said chamber, so as to expose said region to be repaired;

and, after step b), the following step:
resumption of normal operation,

the temperature of the industrial facility being maintained in said region to be repaired during all the steps of the process;
the industrial facility has a chamber containing a fluid product, preferably a powdered or molten product, in particular a molten metal, and said process includes, prior to step a), the following steps:
   1) if the region to be repaired is, at least partially, delimited by a surface of the industrial facility in contact with said fluid product, at least partial emptying of said chamber, so as to expose said region to be repaired;
   3) reducing the temperature in the region to be repaired to a temperature above 250 °C;

And, After Step B), the Following Steps:
5) increasing and maintaining the temperature of the region to be repaired between 1000 °C and 1400 °C so as to sinter the repair product;
6) resumption of normal operation of the industrial facility, i.e. adjustment of the temperature of said industrial facility to its operating temperature;
in step 3) the temperature in the region to be repaired is reduced to a temperature above 900 °C and below 1500 °C;
said process includes a step of rinsing the region to be repaired after exposure of the region to be repaired;
at least one element of the formwork has the shape of a part of the industrial facility which was protruding before said part disappeared as a result of wear, and preferably the manufacture of the formwork involves taking an imprint on a replica of said part of said industrial facility before wear;
the inner formwork includes a plate made of a ceramic material, preferably in the form of a ceramic matrix composite, having two large faces substantially parallel to each other, the ratio of the surface area of one large face (in cm²) to the thickness (in cm, measured between the two large faces) being greater than 30 cm, preferably greater than 50 cm, preferably greater than 100 cm, preferably greater than 200 cm, preferably greater than 500 cm, preferably greater than 1000 cm, preferably greater than 2000 cm, and/or less than 250 000, preferably less than 200 000, preferably less than 150 000, preferably less than 100 000, preferably less than 50 000, preferably less than 10 000, preferably less than 8000, preferably less than 5000, each large face of the plate preferably having a surface area greater than 1000 cm², preferably greater than 1500 cm², preferably greater than 2000 cm², preferably greater than 2500 cm², and/or less than 10000 cm², preferably less than 8000 cm², preferably less than 5000 cm²;
the region to be repaired is at least partly delimited by a side wall and/or a bottom wall of a chamber, for instance of a tank intended to contain a molten product, said formwork including or consisting of an inner formwork installed inside said chamber in step a);
the chamber is closed and inaccessible to an operator;
the region to be repaired is at least partly delimited by a runner.

The features described in the context of a formwork in general are applicable, in the particular case of repairing a chamber, in particular a tank, to an inner formwork, whether or not the formwork used for repairing the chamber includes an outer formwork, and thus whether or not any outer formwork is made of CMC. In particular, at least one element of the inner formwork may have the shape of a part of the chamber which was projecting towards the interior of said chamber before said part disappeared as a result of wear, the manufacture of the inner formwork possibly involving taking an imprint on a replica of the part of said chamber that is not worn away.

The inner formwork may be abandoned in the region to be repaired after said repair.

The invention also relates to an industrial facility, in particular an industrial furnace, including at least one region repaired according to a process according to the invention.

### BRIEF DESCRIPTION OF THE FIGURES

Other features and advantages of the invention will also be seen on examining the following description and from the attached drawing, in which:

FIG. 1 schematically represents a part of a chamber before wear (left-hand scheme) and after wear (right-hand scheme);

FIG. 2 schematically represents a process according to the invention;

FIG. 3 represents an example of a formwork according to the invention;

FIG. 4 represents an example of an inner formwork element including through holes;

FIG. 5 schematically represents a runner for liquid cast iron, before wear, after wear and at the end of step b).

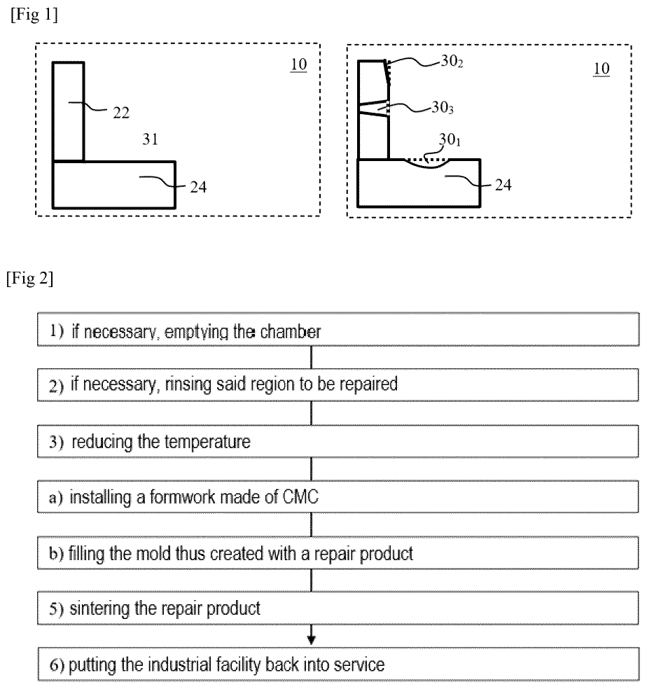

### DEFINITIONS

The term “chamber” means a part of an industrial facility that defines an enclosure. A chamber is delimited laterally by a side wall, the shape of which is not limiting, by a bottom wall, and optionally by a vault wall. The side wall, bottom wall and vault wall may have one or more apertures for access to the enclosure.
The term “tank” denotes a chamber which, when in use, contains a molten product, in particular molten metal.
The term “closed” tank or chamber means a tank or chamber in which an individual cannot enter when it is in service.

The invention is particularly suitable for repairing a chamber, notably a tank, but is not limited to this embodiment.
A “formwork” is a part of the “mold” into which the repair product is introduced.
This is generally achieved by assembling one or more “formwork elements” and positioning the assembled formwork element(s) in the “working position”. The part of the mold defined by the formwork is supplemented with a part of the industrial facility in such a way as to constitute the mold. For example, the part of the inner surface of a chamber that has been worn away may supplement the formwork to delimit the region to be repaired.
In addition to the formwork elements, a formwork includes “accessories”, which are used to assemble and attach the formwork elements in their working position, and which do not come into contact with the repair product during repair. Unlike the accessories, the formwork elements are parts that come into contact with the repair material during repair.
The region to be repaired may be compartmentalized by means of partitions. A partition is considered as a formwork element.
A “passage” is a hole which passes through a wall, for example, thus placing in communication the inner and outer parts of a chamber, for instance a tank, a carbon black reactor or a combustion chamber. It may result from wear on the wall, or it may be designed, for example, to allow formwork elements to be inserted through the wall.
The “equivalent diameter” of a surface is the diameter of a disk of the same area as this surface.
A dry particulate mixture is referred to as an “unshaped product”.
The term “of a material” or “from a material” means a product formed for more than 95%, more than 98% and preferably substantially 100% of its mass of said material.
The term “refractory material” means a material having a melting point above 1500 °C. This definition is commonly used by those skilled in the art, and is mentioned in “Matériaux réfractaires et céramiques techniques (éléments de céramurgie et de technologie)”, G. Aliprandi, published by Septima Paris, 1979. On pages 297 to 301, this book also gives examples of refractory materials, notably oxides, carbides and nitrides.
The “glass transition temperature” of a glass means the temperature at which said glass changes from a solid to a viscous state. The term “glass transition temperature” may be determined by Differential Thermal Analysis (DTA). The glass transition temperature is the temperature at which said glass has a viscosity substantially equal to 1012 Pa·s. Conventionally, glass is considered to be in the solid state at a temperature below its glass transition temperature.
The term “hot binder” means a component with a melting point of greater than 600 °C, that is capable of bonding together particles with which it has been mixed, after hardening by a drop in temperature.
The term “maximum size” refers to the 99.5 percentile (D_{99.5}) of a powder, this percentile corresponding to the 99.5% percentage by mass on the cumulative particle size distribution curve of the powder, the particle sizes being arranged in ascending order. The particle size distributions and the maximum size may be determined using a laser particle size analyzer. The laser particle size analyzer may be a Partica LA-950 machine from the company Horiba.
The term “self-casting at elevated temperature” refers to a repair product that is capable of spreading under its own weight and filling the mold without segregation, in a temperature range from 250 °C to 1550 °C. Segregation is considered to have occurred when the casting face of the product obtained after placement of the repair product and sintering has a surface layer of laitance extending, from said casting face, to a depth of 3 mm or more. This surface layer of laitance may readily be revealed after drying or sintering of the product, the sawing being performed in a plane perpendicular to the casting face.
When reference is made to ZrO₂ or zirconia, this should be understood as ZrO₂ and traces of HfO₂. Specifically, some HfO₂, which is chemically inseparable from ZrO₂ in a fusion process and has similar properties, is always naturally present in zirconia sources at mass contents generally below 2%. Hafnium oxide is thus not considered as an impurity.
The term “Ceramic Matrix Composite”, or “CMC”, conventionally means a ceramic compound made up of a ceramic textile stiffened with a ceramic matrix.
A “textile” is an assembly of fibers, optionally a yarn, in particular a yarn assembly. The textile typically represents between 20% and 80% of the volume of a CMC, the remainder to 100% being the matrix.

In general, when reference is made to a volume percentage relative to an object, for example a CMC (for example a percentage of fibers) or the matrix of a CMC (as in the previous sentence), the volume to be considered is that of the object defined by its outer surface, i.e. it includes the empty spaces inside the object.
A “fiber” is a filament whose length is greater than five times its equivalent diameter.
The “equivalent diameter” of a fiber is the diameter of a disk with the same surface area as its mid-length cross-section.

In a textile, the fibers may be assembled in a disordered manner, as in felt or paper, or in one or more preferential directions, preferably in the form of yarns, which are themselves preferably in the form of one or more fabrics. A textile yarn may be
a “single yarn”, which is an assembly of fibers which, in cross-section, includes more than 10 and preferably less than 500 000 fibers, and whose length is greater than 5 times the diameter, or
an “assembled yarn”, which is an assembly of single yarns which, in cross-section, preferably includes more than 2 and preferably less than 500 single yarns.

In particular, a textile may be:
an organized structure of single or assembled fibers and/or yarns, notably a knitted fabric or woven fabric, or
a random structure of fibers, and/or yarns, single or assembled, for example a web, and/or unincorporated fibers in the form of yarns, said random structure possibly being, for example, a paper or a felt, a random structure not being preferred.

A “fabric” is formed of a network of parallel warp threads and weft threads running transversely through said network.

A “knitted fabric” is constituted of a network of threads having the form of loops.

A “lap” is formed of a set of parallel yarns.

The term “ceramic” refers to a product that is neither metallic nor organic. In the context of the present invention, carbon is considered as a ceramic product.

A “sialon”, SiAlON, is an oxynitride compound of at least the elements Si, Al and N, in particular a compound complying with one of the following formulae:
SiₓAl_{y}OᵤNᵥ, in which:
   x is greater than or equal to 0, greater than 0.05, greater than 0.1 or greater than 0.2, and less than or equal to 1, less than or equal to 0.8 or less than or equal to 0.4,
y is greater than or equal to 0, or greater than 0.1, greater than 0.3 or greater than 0.5, and less than or equal to 1,
u is greater than 0, greater than 0.1 or greater than 0.2, and less than or equal to 1 or less than or equal to 0.7,
v is greater than 0, greater than 0.1, greater than 0.2 or greater than 0.5, or greater than 0.7, and less than or equal to 1,
x+y>0,
x, y, u and v being stoichiometric indices and normalized relative to the highest, made equal to 1;
MeₓSi₁₂₋₍ₘ₊ₙ₎Al₍ₘ₊ₙ₎OₙN₁₆₋ₙ, with 0≤x≤2, Me a cation chosen from the lanthanide cations, Fe, Y, Ca, Li and mixtures thereof, 0≤m≤12, 0≤n≤12 and 0<n+m≤12, the SiAlONs according to this formula being generally referred to as “α′-SiAlON” or “SiAlON-α′”.

The term “include” or “comprise” or “present” are to be interpreted in a non-limiting manner.

### DETAILED DESCRIPTION

### Hot Repair

A process according to the invention is used for the hot repair of a region of an industrial facility. Preferably, the industrial facility is chosen from:
an iron or steel smelting furnace, and a part of such a furnace, in particular an electric arc furnace, a submerged arc furnace, an open slag bath furnace, a blast furnace, a basic oxygen furnace, a direct reduction iron shaft furnace, a runner, a metal and iron reheat furnace, a holder and melter furnace, a tundish;
a non-ferrous metal melting furnace, in particular an aluminum melting furnace, a magnesium melting furnace or a copper melting furnace;
an element physically independent of a melting furnace or physically detachable from a metal melting furnace, in contact with said molten metal and allowing said molten metal to be transferred from said melting furnace to another facility, in particular a transfer ladle;
a cement kiln, notably a rotary kiln;
an ore reduction furnace, notably an iron ore reduction furnace;
an incinerator, notably a domestic waste incinerator or a household waste incineration boiler;
a furnace for treating hazardous waste;
a gasifier, notably a coal gasifier, a petroleum coke gasifier or a biomass gasifier;
a reformer, notably a methane reformer or a secondary reformer;
a ceramic firing furnace;
a carbon black reactor;
a retention tank intended to retain a product at a temperature in excess of 250 °C in the event of accidental spillage of said product;
an aluminum electrolysis cell;
a combustion chamber of a turbine, in particular a gas turbine;
a boiler, in particular a power plant boiler.

The region to be repaired may in particular be located in a wall of the industrial facility, for example in the side wall of a chamber, for example a tank, of said industrial facility, in particular a wall of a closed chamber, in particular a closed tank.

The invention is particularly useful for repairing the side wall 22 of a chamber. Specifically, it is thus necessary to retain the repair product in order to prevent it from flowing away under gravity. This problem does not generally arise when repairing the bottom wall of the chamber. The use of ceramic formwork elements, in the form of plates in particular, and notably a ceramic in the form of a CMC, advantageously allows a formwork to be made which does not need to be cooled. This formwork may thus be lighter (in particular if it is made using thin plates). In addition, due to the absence of cooling and the fact that it can be left in place after repair, this formwork is very quick to install and does not need to be dismantled. This advantageously reduces the down time of the industrial facility for repair purposes. Finally, the formwork can be complex in shape.

The region to be repaired may have the shape of a cavity, which may or may not be traversing, for example a sunken region, notably due to wear, for example leading to the inside of a chamber in the industrial facility.

FIG. 2 shows an example of a process according to the invention.

In one embodiment, in particular for repairing a chamber including a wall in contact with a fluid product, in particular a molten or pulverulent product, in the region to be repaired,
for example, for repairing a tank in an iron or steel smelting furnace, or a non-ferrous metal melting furnace, notably an aluminum melting furnace, a magnesium melting furnace, a copper melting furnace, or for repairing a runner, notably for such furnaces, or even for repairing an incinerator tank,
the process includes a step 1) of at least partially emptying said chamber, so as to expose the region to be repaired.

The fluid product may notably be in liquid or pulverulent form, for example in the form of ash.

Emptying may be performed using any technique known to the skilled person.

For example, fluid product, notably molten product or ash, can be discharged through passages, for example drilled in the bottom wall of the chamber or created by removing one or more electrodes or burners.

Step 1) is optional for repairing a chamber with an exposed part to be repaired, for example a part to be repaired which is not in contact with a fluid product, notably a molten product or with ash, for example for repairing a vault wall, or a turbine chamber wall, or a ceramic firing furnace.

In optional step 2), the region to be repaired is rinsed, i.e. freed from a large amount of product residues with which it has been in contact during the use of the industrial facility, via any conventional technique. Preferably, at least the region to be repaired is sprayed with a suitable product, notably to fluidize the residues of the product with which it has been in contact during use, so as to facilitate the removal of said residues. For example, sodium carbonate spray is particularly suitable for fluidizing metallurgical slag residue.

In optional step 3), the temperature in the region to be repaired may be reduced to above 250 °C, preferably above 400 °C, preferably above 500 °C, preferably above 600 °C, preferably above 700 °C, preferably above 800°C, preferably above 900 °C, and preferably below 1550 °C, preferably below 1500 °C, or even below 1450 °C or 1400 °C.

In one embodiment, the repair product used in step b) contains a hot binder, and in step 3), the temperature in the region to be repaired is reduced to a temperature at which the hot binder is not in the solid state. In particular, when the hot binder is a glass, the temperature is reduced to a temperature which remains above the glass transition temperature of said glass. Said glass is preferably chosen so that its glass transition temperature is between 600 °C and 1350 °C, preferably between 900 °C and 1350 °C, more preferably between 1000 °C and 1300 °C, most preferably between 1150°C and 1250 °C.

In step 4), the repair product is applied according to steps a) and b).

In step a), the region to be repaired is delimited using formwork 32, so as to constitute, together with the industrial facility, in particular an industrial furnace, a mold for the repair product.

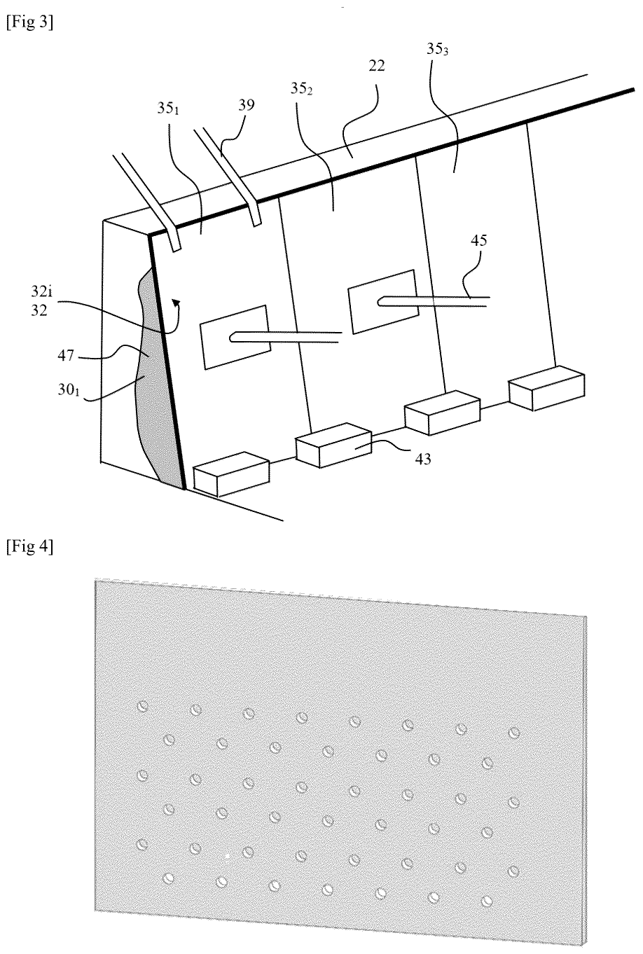

The formwork 32 includes or even consists of (FIG. 3) an inner formwork 32i, which delimits the mold inside the industrial facility. In particular, the inner formwork follows the aperture of the cavity-shaped regions to be repaired 301.

When the region to be repaired passes through a wall of the industrial facility, in particular the wall of a chamber, for example the wall of a tank containing molten product during operation, it opens out through inner and outer apertures on the inner and outer faces of the wall, respectively. Preferably, the formwork 32 then includes an outer formwork, not represented, which delimits the outer aperture of the region to be repaired. The inner and outer formwork retain the repair product before it is hardened, preferably sintered, so that it does not escape through the inner and outer apertures, respectively.

According to the invention, at least a part of the inner formwork, preferably the entire inner formwork, is made of CMC.

In one embodiment, at least a portion of the outer formwork, or even the entire outer formwork, is made of CMC.

In one embodiment, the outer formwork is made of CMC, preferably identical to that of the inner formwork.

The manufacture of a CMC can be performed via any conventional method.

A person skilled in the art will be able to adjust the parameters of the process chosen for CMC manufacture, and in particular determine the particle size of the starting materials, the water content during shaping, and the sintering temperature if the CMC is sintered.

In particular, the manufacture of a CMC may comprise the following steps:
i) placing, on or in a textile, a slip that is capable of forming a ceramic matrix after consolidation;
ii) before or after step i), forming the textile into shape;
iii) consolidation of the preform obtained after the preceding steps, preferably by drying and/or sintering, so as to form said matrix and to obtain the CMC.

In step i), the textile is an assembly of fibers, preferably assembled in the form of yarns, a yarn typically including several hundred to several thousand fibers. The fibers, preferably the yarns, preferably have a length greater than 50 mm, or even greater than 100 mm. In one embodiment, the fibers, preferably the yarns, are arranged in the form of at least one fabric.

The textile may notably take the form of a felt of unordered yarns and/or fibers, a lap, for example a lap consisting of yarns running substantially parallel to one another (said yarns being referred to as “unidirectional yarns”), a knitted fabric, a woven fabric (i.e. a woven textile) or a stack of one or more felts and/or laps, and/or knitted fabrics and/or woven fabrics.

Preferably, the textile is in the form of a felt or fabric or lap or a stack of felt(s) and/or lap(s) and/or fabric(s). The stacking of fabrics and/or laps may be performed in such a manner that the yarns of the different fabrics or laps all extend substantially in the same direction, or in 2, 3, 4, 5 or 6 different directions, notably as a function of the desired mechanical properties.

Preferably, at least a portion, and preferably all, of said ceramic fibers of the textile, optionally assembled in the form of single and/or assembled yarns, are:
fibers including more than 95%, preferably more than 97%, preferably more than 98%, preferably more than 99%, preferably more than 99.5% by mass of oxides, and/or
fibers including more than 95%, preferably more than 97%, preferably more than 98%, preferably more than 99%, preferably more than 99.5% by mass of a material other than an oxide.

Preferably, said textile ceramic fibers including more than 95%, preferably more than 97%, preferably more than 98%, preferably more than 99%, preferably more than 99.5% by mass of oxides are:
fibers including more than 95%, preferably more than 97%, preferably more than 98%, preferably more than 99%, preferably more than 99.5% by mass of oxides and having a chemical analysis such that SiO₂+Al₂O₃+ZrO₂>50%, preferably SiO₂+Al₂O₃+ZrO₂>60%, or even SiO₂+Al₂O₃+ZrO₂>70%, or even SiO₂+Al₂O₃+ZrO₂>80%, or even SiO₂+Al₂O₃+ZrO₂>90%, by mass percentage, and/or
fibers including more than 95%, preferably more than 97%, preferably more than 98%, preferably more than 99%, preferably more than 99.5% by mass of oxides and having a chemical analysis such that SiO₂>70%, preferably SiO₂>80%, preferably SiO₂>90%, or even SiO₂>99%, by mass percentage, and/or
fibers including more than 95%, preferably more than 97%, preferably more than 98%, preferably more than 99%, preferably more than 99.5% by mass of oxides and having a chemical analysis such as Al₂O₃>65%, preferably Al₂O₃>70%, or even Al₂O₃>80%, or even Al₂O₃>90%, or even Al₂O₃>95%, by mass percentage.

Even more preferably, at least a portion, and preferably all, of said ceramic fibers are:
fibers made up to more than 95%, preferably more than 98%, preferably more than 99%, preferably substantially 100% by mass of alumina, and/or
fibers made up to more than 95%, preferably more than 98%, preferably more than 99%, preferably substantially 100% by mass of silica, preferably made up to more than 95%, preferably more than 98%, of amorphous silica, and/or
fibers made up to more than 95%, preferably more than 98%, preferably more than 99%, preferably substantially 100% by mass, of mullite and corundum, and/or
fibers made up to more than 95%, preferably more than 98%, preferably more than 99%, preferably substantially 100% by mass of glass, preferably washed, and/or
a mixture of said fibers.

Preferably, said ceramic fibers of the textile including more than 95%, preferably more than 97%, preferably more than 98%, preferably more than 99%, preferably more than 99.5% by mass of a material other than an oxide are:
fibers including more than 95%, preferably more than 97%, preferably more than 98%, preferably more than 99%, preferably more than 99.5% by mass of a carbide, preferably chosen from silicon carbide, boron carbide and mixtures thereof, and/or
fibers including more than 95%, preferably more than 97%, preferably more than 98%, preferably more than 99%, preferably more than 99.5% by mass of a boride, preferably a titanium boride, and/or
fibers including more than 95%, preferably more than 97%, preferably more than 98%, preferably more than 99%, preferably more than 99.5% by mass of a nitride, preferably a silicon nitride, and/or
fibers including more than 95%, preferably more than 97%, preferably more than 98%, preferably more than 99%, preferably more than 99.5% by mass of carbon.

Preferably, said ceramic fibers of the textile including more than 95%, preferably more than 97%, preferably more than 98%, preferably more than 99%, preferably more than 99.5% by mass of a material other than an oxide are:
fibers including more than 95%, preferably more than 97%, preferably more than 98%, preferably more than 99%, preferably more than 99.5% by mass of silicon carbide, and/or
fibers including more than 95%, preferably more than 97%, preferably more than 98%, preferably more than 99%, preferably more than 99.5% by mass of carbon.

In one embodiment, at least a portion, and preferably all, of said ceramic fibers are fibers including more than 95%, preferably more than 97%, preferably more than 98%, preferably more than 99%, preferably more than 99.5% by mass of oxides.

In one embodiment, at least a portion, and preferably all, of said ceramic fibers are fibers including more than 95%, preferably more than 97%, preferably more than 98%, preferably more than 99%, preferably more than 99.5% by mass of a material other than an oxide.

In one embodiment, substantially all the fibers have the same composition.

The slip may be arranged on or in the textile by impregnation, for example. Said stacking may be performed by pressing, or under vacuum, preferably after impregnation.

The manufacture of slips is well known to those skilled in the art. The slip is conventionally a suspension, for example of an aqueous base or of an organic solvent, containing
ceramic particles and/or ceramic particle precursors, i.e. compounds which become ceramic particles during the manufacture of the CMC, and in particular during hardening, in particular sintering, and
optionally dispersants, plasticizers, lubricants and/or temporary binders.

The composition of the slip, the size distribution of the ceramic particles or ceramic precursors and the mineral filler in the slip are suitable for the type of fiber and the forming technique. For example, the slip may be applied to or in the textile, notably by direct lamination, infusion, injection molding, infiltration or deposition, under atmospheric or higher pressure or vacuum, at room temperature or higher.

In step ii), the textile obtained, preferably impregnated with the slip, is formed into shape. The desired shape is preferably the final shape of the CMC. In one embodiment, however, the shape may be modified after the matrix has hardened, for example by machining or deformation.

Preferably, to make the inner formwork, the textile is formed into shape so that the shape of the CMC is suitable so that, after installation of the formwork, the repair material only replaces material that has been extracted by wear, preferably replaces all the material that has been extracted by wear.

The shape can be given by taking an imprint on a reproduction of the part of the industrial facility to be repaired before wear, using the textile (before or preferably after introduction of the slip). The mold is thus a “negative” of the region to be repaired. For example, if the region to be repaired is a runner, the CMC may be made by depositing the textile, preferably in the form of a fabric or an overlapping of several fabrics, on a replica of said runner, before or after impregnation with the slip but before consolidation, in such a way that this textile conforms to the surface of the runner, at least in the region corresponding to the region to be repaired. The use of CMC advantageously allows easy production of complex shapes that potentially cannot be developed. The repair thus allows precise reconstruction of the initial profile of the surface of the industrial facility, in particular the inner surface of a chamber, for example a tank, of the industrial facility.

The CMC can be manufactured by arranging prepregs, each consisting of a fabric impregnated with a ceramic particle slip, one on top of the other. The prepregs are flexible, so as to be capable of taking any desired shape.

In step iii), consolidation, preferably by sintering, is preferably performed before the formwork is installed, thus facilitating this installation.

In general, the features of the CMC result from its manufacturing process.

Preferably, the CMC has one or more of the following optional features:
the CMC is preferably sintered;
the CMC preferably has an open porosity, measured by imbibition according to Archimedes' buoyancy principle, of greater than 10%, preferably greater than 15%, preferably greater than 20%, preferably greater than 25%, preferably greater than 30%, and preferably less than 50%, preferably less than 45%, preferably less than 40%;
Preferably, the CMC includes more than 20%, preferably more than 25%, preferably more than 30%, preferably more than 40%, preferably more than 50%, preferably more than 60% and/or less than 80%, preferably less than 70% by volume of fibers;
at least a portion, and preferably all, of the CMC ceramic fibers are fibers including more than 95%, preferably more than 97%, preferably more than 98%, preferably more than 99%, preferably more than 99.5% by mass of oxides;
at least a portion, and preferably all, of the CMC ceramic fibers are fibers including more than 95%, preferably more than 97%, preferably more than 98%, preferably more than 99%, preferably more than 99.5% by mass of a material other than an oxide;
the CMC matrix is made up to more than 90%, preferably to more than 95%, preferably to more than 97%, preferably to more than 98%, preferably to more than 99%, preferably to more than 99.5% by mass of
oxides, and/or
and/or nitrides and/or sialons, in particular of the type described above;
the CMC has a bulk density of greater than 1.0 g/cm³, preferably greater than 1.20g/cm³, preferably greater than 1.40 g/cm³ and/or less than 2.50 g/cm³, preferably less than 2.00 g/cm³, preferably less than 1.90 g/cm³.

In a first embodiment, the CMC is constituted of oxides for more than 90% of its mass, preferably for more than 95% of its mass, preferably for more than 98% of its mass, preferably for more than 99% of its mass, preferably for more than 99.5% of its mass.

In said first embodiment, the CMC has one or more of the following optional and preferred features:
the CMC includes fibers, said fibers being composed of oxides for more than 90%, preferably for more than 95%, preferably for more than 97%, preferably for more than 98%, preferably for more than 99%, preferably for more than 99.5% by mass;
at least a portion, and preferably all, of said ceramic fibers are:
   fibers including more than 95%, preferably more than 97%, preferably more than 98%, preferably more than 99%, preferably more than 99.5% by mass of oxides and having a chemical analysis such that SiO₂+Al₂O₃+ZrO₂>50%, preferably SiO₂+Al₂O₃+ZrO₂>60%, or even SiO₂+Al₂O₃+ZrO₂>70%, or even SiO₂+Al₂O₃+ZrO₂>80%, or even SiO₂+Al₂O₃+ZrO₂>90%, by mass percentage, and/or
   fibers including more than 95%, preferably more than 97%, preferably more than 98%, preferably more than 99%, preferably more than 99.5% by mass of oxides and having a chemical analysis such that SiO₂>70%, preferably SiO₂>80%, preferably SiO₂>90%, or even SiO₂>99%, by mass percentage, and/or
   fibers including more than 95%, preferably more than 97%, preferably more than 98%, preferably more than 99%, preferably more than 99.5% by mass of oxides and having a chemical analysis such that Al₂O₃>65%, preferably Al₂O₃>70%, or even Al₂O₃>80%, or even Al₂O₃>90%, or even Al₂O₃>95%, or even Al₂O₃>97%, or even Al₂O₃>98%, by mass percentage;
the matrix of said CMC is made up of oxides for more than 90%, preferably for more than 95%, preferably more than 97%, preferably more than 98%, preferably more than 99%, preferably more than 99.5% by mass;
preferably, the CMC matrix is substantially formed of oxides;
the CMC matrix comprises Al₂O₃ and/or SiO₂and/or ZrO₂ and/or Cr₂O₃;
preferably, the CMC matrix comprises Al₂O₃ and SiO₂;
in one embodiment, the Al₂O₃ content of the CMC matrix, as a mass percentage based on the mass of the matrix, is greater than 65%, preferably greater than 70%;
in one embodiment, the SiO₂ content of the CMC matrix, as a mass percentage based on the mass of the matrix, is greater than 15%, preferably greater than 20% and/or less than 35%, preferably less than 30%;
in one embodiment, the SiO₂ content of the CMC matrix, as a mass percentage based on the mass of the matrix, is greater than 60%, preferably greater than 70%, preferably greater than 80%;
in one embodiment, the content of oxides other than Al₂O₃ and SiO₂ in the CMC matrix, as a mass percentage based on the mass of the matrix, is less than 3%, preferably less than 2%, preferably less than 1%;
in one embodiment, the total Al₂O₃ and SiO₂ content of the CMC matrix is greater than 80%, preferably greater than 85%, preferably greater than 90%, preferably greater than 95%, as a mass percentage based on the mass of the matrix;
in one embodiment, the silica of the CMC matrix is amorphous;
preferably, the CMC has a total SiO₂+Al₂O₃+ZrO₂+Cr₂O₃ mass content of greater than 80%, preferably greater than 85%, preferably greater than 90%, preferably greater than 95%, preferably greater than 97%. Even more preferably, the CMC has a total SiO₂+Al₂O₃ mass content of greater than 80%, preferably greater than 85%, preferably greater than 90%, preferably greater than 95%, preferably greater than 97%, preferably greater than 97%;
in a preferred embodiment, the CMC has the following chemical analysis, by mass percentage and for a total of 100%:
Al₂O₃: 32%-52%,
species other than Al₂O₃ and SiO₂: <5%, preferably <4%, preferably <3%, preferably <2%;
in one embodiment, the CMC is preferably amorphous, and has the following chemical analysis, as a mass percentage and for a total of 100%:
SiO₂: >95%, preferably >96%, preferably >97%, preferably >98%, preferably >99%.

In a second embodiment, the CMC is constituted of a material other than an oxide, to more than 90% of its mass, preferably to more than 95% of its mass, preferably to more than 98% of its mass, preferably to more than 99% of its mass, preferably to more than 99.5% of its mass.

In said second embodiment, the CMC has one or more of the following optional and preferred features:
the CMC includes fibers, said fibers being composed of a material other than oxides for more than 90%, preferably for more than 95%, preferably for more than 97%, preferably for more than 98%, preferably for more than 99%, preferably for more than 99.5% by mass;
at least a portion, and preferably all, of said ceramic fibers are:
   fibers including more than 95%, preferably more than 97%, preferably more than 98%, preferably more than 99%, preferably more than 99.5% by mass of carbon, and/or
   fibers including more than 95%, preferably more than 97%, preferably more than 98%, preferably more than 99%, preferably more than 99.5% by mass of a carbide, preferably chosen from silicon carbide, boron carbide and mixtures thereof, and/or
   fibers including more than 95%, preferably more than 97%, preferably more than 98%, preferably more than 99%, preferably more than 99.5% by mass of a boride, preferably a titanium boride, and/or
   fibers including more than 95%, preferably more than 97%, preferably more than 98%, preferably more than 99%, preferably more than 99.5% by mass of a nitride, preferably a silicon nitride, and/or
   fibers including more than 95%, preferably more than 97%, preferably more than 98%, preferably more than 99%, preferably more than 99.5% by mass of carbon.

In said second embodiment, the CMC has one or more of the following optional and preferred features:
preferably, said ceramic fibers of the textile including more than 95%, preferably more than 97%, preferably more than 98%, preferably more than 99%, preferably more than 99.5% by mass of a material other than an oxide are fibers including more than 95%, preferably more than 97%, preferably more than 98%, preferably more than 99%, preferably more than 99.5% by mass of silicon carbide, and/or fibers including more than 95%, preferably more than 97%, preferably more than 98%, preferably more than 99%, preferably more than 99.5% by mass of carbon;
the matrix of said CMC is made up of more than 90%, preferably more than 95%, preferably more than 97%, preferably more than 98%, preferably more than 99%, preferably more than 99.5% by mass of a material other than an oxide, preferably chosen from carbides, borides, nitrides, SiAlON and mixtures thereof;
preferably, the CMC matrix comprises or even consists of silicon carbide, silicon nitride, silicon metal or mixtures thereof;
in a particular embodiment of the second embodiment, the CMC includes fibers comprising more than 95%, preferably more than 97%, preferably more than 98%, preferably more than 99%, preferably more than 99.5% by mass of silicon carbide, and/or fibers including more than 95%, preferably more than 97%, preferably more than 98%, preferably more than 99%, preferably more than 99.5% by mass of carbon, and a matrix made up of more than 90%, preferably more than 95%, preferably more than 97%, preferably more than 98%, preferably more than 99%, preferably more than 99.5% by mass of silicon carbide, silicon nitride, silicon metal, and mixtures thereof. In said embodiment, the matrix is preferably made up, to more than 90%, preferably to more than 95%, preferably to more than 97%, preferably to more than 98%, preferably to more than 99%, preferably to more than 99.5% by mass, of silicon carbide or a mixture of silicon carbide and silicon metal or a mixture of silicon carbide and silicon nitride;
in one embodiment, the silicon carbide in the matrix is a recrystallized silicon carbide.

In a third embodiment, the CMC includes
fibers made up of a material other than an oxide to more than 90%, preferably to more than 95%, preferably to more than 97%, preferably to more than 98%, preferably to more than 99%, preferably to more than 99.5% by mass and
a matrix made up of oxides to more than 90%, preferably to more than 95%, preferably to more than 97%, preferably to more than 98%, preferably to more than 99%, preferably to more than 99.5% by mass.

In said third embodiment, the CMC has one or more of the following optional and preferred features:
at least a portion, and preferably all, of the fibers made up of a material other than an oxide to more than 90%, preferably to more than 95%, preferably to more than 97%, preferably to more than 98%, preferably to more than 99%, preferably to more than 99.5% by mass, are fibers including more than 95%, preferably more than 97%, preferably more than 98%, preferably more than 99%, preferably more than 99.5% by mass of carbon and/or fibers including more than 95%, preferably more than 97%, preferably more than 98%, preferably more than 99%, preferably more than 99.5% by mass of carbide, preferably silicon carbide, and/or
the CMC matrix comprises, or even consists of, Al₂O₃ and/or SiO₂ and/or ZrO₂ and/or Cr₂O₃;
preferably, the CMC matrix comprises or even consists of Al₂O₃ and SiO₂;
in one embodiment, the Al₂O₃ content of the CMC matrix, as a mass percentage based on the matrix, is greater than 65%, preferably greater than 70%;
in one embodiment, the SiO₂ content of the CMC matrix, as a mass percentage based on the matrix, is greater than 15%, preferably greater than 20% and/or less than 35%, preferably less than 30%;
in one embodiment, the SiO₂ content of the CMC matrix, as a mass percentage based on the matrix, is greater than 60%, preferably greater than 70%, preferably greater than 80%;
in one embodiment, the content of species other than Al₂O₃ and SiO₂ in the CMC matrix, as a mass percentage based on the matrix, is less than 3%, preferably less than 2%, preferably less than 1%;
in one embodiment, the total content of Al₂O₃ and SiO₂ in the CMC matrix is greater than 80%, preferably greater than 85%, preferably greater than 90%, preferably greater than 95%, as a mass percentage based on the matrix;
in one embodiment, the silica in the CMC matrix is amorphous.

In a fourth embodiment, the CMC includes
fibers made up of oxides to more than 90%, preferably to more than 95%, preferably to more than 97%, preferably to more than 98%, preferably to more than 99%, preferably to more than 99.5% by mass, and
a matrix made up of more than 90%, preferably more than 95%, preferably more than 97%, preferably more than 98%, preferably more than 99%, preferably more than 99.5% by mass of a material other than an oxide, preferably chosen from carbon, carbides, borides, nitrides and SiAlON.

In said fourth embodiment, the CMC preferably has one or more of the following optional features:
the CMC includes fibers having a chemical analysis such that SiO₂+Al₂O₃+ZrO₂>50%, preferably SiO₂+Al₂O₃+ZrO₂>60%, or even SiO₂+Al₂O₃+ZrO₂>70%, or even SiO₂+Al₂O₃+ZrO₂>80%, or even SiO₂+Al₂O₃+ZrO₂>90%, as a mass percentage;
the CMC includes fibers having a chemical analysis such that SiO₂>70%, preferably SiO₂>80%, preferably SiO₂>90%, or even SiO₂>99%, as a mass percentage;
the CMC includes fibers having a chemical analysis such that Al₂O₃>65%, preferably Al₂O₃>70%, or even Al₂O₃>80%, or even Al₂O₃>90%, or even Al₂O₃>95%, or even Al₂O₃>97%, or even Al₂O₃>98%, as a mass percentage;
the CMC matrix is preferably made up, for more than 90%, preferably for more than 95%, preferably for more than 97%, preferably for more than 98%, preferably for more than 99%, preferably for more than 99.5% by mass, of silicon carbide or a mixture of silicon carbide and silicon metal or a mixture of silicon carbide and silicon nitride.

In one embodiment, the CMC is chosen so as to have a chemical analysis close to that of the material of the industrial plant which delimits the region to be repaired, preferably so that the content of any constituent of the sintered repair product present in a mass content greater than 5%, differs by less than 20%, preferably less than 10%, from the content of said constituent in said material.

The formwork is then installed by assembling its elements.

Installation of the inner formwork in a chamber may be tricky due to access difficulties.

The inner formwork elements may be placed through a passageway that opens out inside the chamber, in the region to be repaired or not.

During installation, the inner formwork elements which have two opposing large faces may be held by the large face which, in the working position, is exposed to the inside of the industrial facility, or by the opposing large face.

In one embodiment, as shown in FIG. 4, at least one element of the formwork, in particular of the inner formwork, in a CMC includes through holes and/or recesses. Filling these holes and recesses with repair product during step b) advantageously allows better immobilization of the inner formwork and thus reduces the thermal gradient in the repair product during step 5). Preferably, the mean equivalent diameter of the holes is greater than 8 mm and preferably less than 20 mm, preferably less than 15 mm.

In one embodiment, said formwork element made of a CMC is in the form of a grid, the holes preferably being evenly distributed, the total surface area of the holes representing more than 10%, preferably more than 15% and preferably less than 50%, preferably less than 40% of the inner surface area of said formwork element, i.e. the surface area included in defining the mold around the region to be repaired (surface area of holes and of the grid material).

In one embodiment, said holes are located on the lower two-thirds of said formwork element, and are preferably evenly distributed. More preferably, in said embodiment, the total surface area of the holes represents more than 1% and less than 5% of the inner surface area of said formwork element (surface area of the holes and of the material of said formwork element).

The through-holes and/or recesses may be produced via any technique known to those skilled in the art. In particular, the through-holes can be made by drilling or water-jet cutting of the CMC obtained after sintering. The through-holes and/or recesses may also be made on the textile, preferably a woven fabric, prior to coating with the slip.

Accessories are then conventionally used to hold the formwork elements in the working position.

In one embodiment, the seal between the formwork, in particular the inner formwork, and the surface of the industrial facility defining the region to be repaired is increased by arranging a lap of ceramic fibers between said formwork and said surface.

FIG. 3 shows an example of inner formwork according to the invention. In particular, the inner formwork 32i can be seen, and in particular three adjacent panels 351, 352 and 353 are held in position by metal clamps 39, wedge bricks 43 and cooled tubes 45. Repair product 47 fills the region to be repaired 301 delimited by the surface of the worn region and the inner formwork. Once the formwork has been installed, the repair product can be introduced into the region to be repaired, for example via a water-cooled rod.

In step b), filling of the mold delimiting the region to be repaired with a repair product is performed, preferably by casting.

### Repair Product

The repair product may be a conventional repair product and may be prepared via any known technique.

Preferably, the repair product is the result of humidifying an unshaped product. Said humidification may be performed via any known technique, for example in a mixer. A person skilled in the art knows how to determine the amount of solvent, preferably water, to be used to humidify the unshaped product and to obtain the repair product.

The unshaped product may notably be:
Pural T concrete and/or Pural M concrete, in particular when the industrial facility is an iron or steel smelting furnace, and a part of such a furnace, a furnace for melting a non-ferrous metal, or even an element configured for transferring molten metal, in particular from a furnace for melting said metal, said element possibly being physically disengaged from said furnace,
Sialfrax 18 Cast, Sialfrax 30 Shot, Alfrax 60 Shot or Castfrax 902, in particular when the industrial facility is a runner.

These unshaped products are sold by the company Saint-Gobain Performance Ceramics & Refractories.

Preferably, the maximum particle size of the repair product or, equivalently, of the unshaped product, is less than 10 mm, preferably less than 8 mm, most preferably less than 6 mm.

The particle size distribution of the repair product or, equivalently, of the unshaped product is preferably determined so that the repair product is a hot free-flowing product.

Preferably, the repair product is chosen so as to have, after sintering, a chemical analysis close to that of the material of the industrial facility which delimits the region to be repaired, preferably so that the mass content of any constituent of the sintered repair product present in a mass content greater than 5%, differs by less than 20%, preferably by less than 10%, from the content of said constituent in said material.

In one embodiment, the repair product is chosen so as to have, after sintering, a chemical analysis close to that of the CMC of the formwork elements, preferably so that the mass content of any constituent of the sintered repair product present in a mass content greater than 5%, differs by less than 20%, preferably by less than 10%, from the content of said constituent in said CMC.

For example, if the region to be repaired is delimited by one or more refractory blocks made of a product with a high alumina content, the unshaped product used to manufacture the repair product is preferably Pural T concrete.

The repair product may be supplied to the region to be repaired using any technique known to those skilled in the art.

If access to the region to be repaired is difficult, one or more passages, for example drilled, may be provided to facilitate access. These passages advantageously allow the introduction of a device for conveying the repair product, for example a cooled rod, to the region to be repaired. In one embodiment, the repair product is pumped by means of a pump producing a suction pressure preferably less than or equal to 180 bar, and preferably conveyed to the region to be repaired by means of a water-cooled rod or a nozzle.

Throughout step b), the region to be repaired is preferably maintained at a temperature above 300 °C, preferably above 400 °C, preferably above 500 °C, preferably above 600 °C, preferably above 700 °C, preferably above 800 °C, preferably above 900 °C, and/or preferably below 1550 °C, preferably below 1500 °C.

In optional step 5), and notably if the process includes a step 3), the industrial facility is maintained at a temperature of between 400 °C and 1400 °C, preferably between 600 °C and 1400 °C, preferably between 1000 °C and 1400 °C, so as to allow sintering of the repair product, preferably for more than 8 hours, preferably for more than 10 hours and preferably for less than 15 hours.

In step 6), normal operation of the facility is resumed, and if the process includes a step 3), the temperature of the industrial facility is raised for restarting.

### EXAMPLES

The following nonlimiting examples are given to illustrate the invention.

In a first particular embodiment, notably when the region to be repaired belongs to a wall separating an “inner” space and an “outer” space, the inner formwork is made of a CMC, preferably of one or more plates of a CMC, preferably held against the sound wall part by means of one or more metal rods, preferably cooled by means of water circulation. If the region to be repaired opens out on the outer side of the wall, an outer formwork, preferably made of a ceramic, preferably in the form of a CMC, is attached so as to externally close the region to be repaired.

The region to be repaired is then filled with the repair product. Preferably, the repair product is fed from the outside via a pipe through one or more passages in the wall, and then poured into the region to be repaired using a rod cooled by circulating water.

Preferably, at least the inner formwork, preferably the formwork, is not removed after the repair product has been applied.

In a second particular embodiment, notably when the region to be repaired results from wear on a tank in the industrial facility, said tank is at least partially emptied. The inner formwork is made of a CMC, preferably of one or more plates of a CMC, preferably held against the tank using one or more tubes made of a ceramic, preferably in the form of a CMC, and/or one or more metal rods, which are preferably cooled by circulating water. If the region to be repaired opens out toward the outside of the tank, a veneer, constituting the outer formwork, preferably made of a ceramic material, preferably in the form of a CMC, is attached so as to externally close the region to be repaired.

The region to be repaired is then filled with the repair product. Preferably, the repair product is fed from outside the tank via a pipe through one or more passages made in the tank wall, and then poured into the region to be repaired using a rod cooled by circulating water.

Preferably, the CMC formwork is not removed after the repair product has been applied.

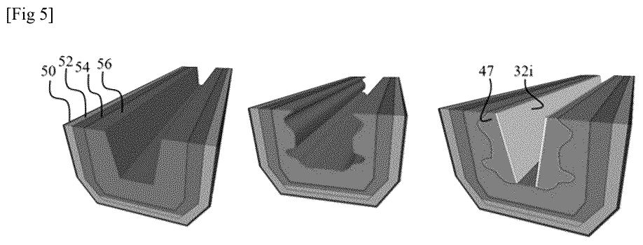

FIG. 5 illustrates the repair of a runner initially formed, from the outside in, by a metal envelope 50, a thermal insulation layer 52, an outer lining 54 and an inner lining 56 (left-hand scheme). The central scheme illustrates the runner after wear of the inner lining 56, and the right-hand figure shows the runner after repair.

### The Following Example Was Performed.

To manufacture the repair product, the unshaped product Castfrax 902 SRAW, sold by the company Saint-Gobain Performance Ceramics & Refractories, was mixed, for 1 minute, in a mixer with a rotating paddle and a fixed tank, with 0.15% of a modified polycarboxylate ether, as mass percentages based on the unshaped product. Then 8% water, as mass percentages based on the unshaped product, was added and mixing was continued until a homogeneous repair product was obtained.

160 kg of repair product were prepared. This repair product was a hot free-flowing product.

A single-piece CMC mold was produced.

This mold had a generally rectangular parallelepiped shape, with a length equal to 600 mm, a width equal to 150 mm, and a height equal to 450 mm, the thickness of the walls of said mold being substantially constant and equal to 10 mm.

The CMC constituting the mold had a thermal conductivity between 20 °C and 500 °C of less than 0.6 W·m⁻¹·K¹.

The CMC consisted of:
a superposition of woven fabrics made of leached glass fibers including a silica content of more than 90% by mass, representing 44% of the CMC mass, and
an alumina and silica matrix, representing 56% of the CMC mass.

Said CMC had an open porosity equal to 38%, a bulk density equal to 1.65 g/cm³, an Al₂O 3 content equal to 42%, an SiO₂ content equal to 57% and a content of other constituents, for example oxides, equal to 1%, the contents of Al₂O₃, SiO₂ and other constituents being expressed as mass percentages on the basis of said CMC.

The mold was placed in a furnace including a gas burner.

The furnace was then started up so as to reach a temperature of 1200 °C in 2 hours 40 minutes, simulating hot introduction of the CMC mold into an industrial facility, in particular a blast furnace cast iron runner.

The repair product was poured into the mold, which was maintained at 1200 °C, using a metal chute positioned above an aperture in the furnace roof.

The repair product was poured in a continuous manner, with a flow rate substantially equal to 100 kg/min.

During filling, the CMC mold was found to resist the thrust of the repair product, without breaking or opening.

After filling the mold, the temperature was maintained at 1200 °C for 4 hours. The temperature was then gradually reduced to 800 °C, at a rate roughly equal to 25 C/hr. The burner was then switched off and the temperature reduced autonomously, without opening the furnace.

The sintered repair product in the mold was then recovered.

After sawing, it had a homogeneous texture, with no cracks or internal cavities that might indicate a break in the feed.

As may now clearly be seen, the invention thus provides a hot repair process which uses elements made of CMC, notably to produce the inner formwork, which:
allows rapid manufacture, perfectly suited to the region to be repaired, in particular because the CMC can be formed into complex shapes, notably so as to match the profile of the region to be repaired;
facilitates the introduction of these elements into the region to be repaired;
facilitates their arrangement, these elements being lightweight;
allows the formwork element to be sacrificed, i.e. maintained in position after repair, in particular because the composition of a CMC may be chosen to be similar to that of the repair product.

Needless to say, the present invention is not limited to the embodiments described or represented, provided as illustrative and nonlimiting examples.

In particular, the CMC compositions of the various formwork parts and/or accessories may be identical or different.

1. A process for the hot repair a region of an industrial facility, said region being at a temperature above 250 °C, referred to as the “region to be repaired”, said process including the following steps:
a) installation of a formwork in a working position, so as to make a mold around the region to be repaired;
b) filling the mold with a repair product,
at least a portion of the formwork being made of Ceramic Matrix Composite,
the industrial facility being different from a glassmaking furnace.

2. The process as claimed in claim 1, in which the industrial facility is chosen from:
an iron or steel smelting furnace, and a part of such a furnace;
a furnace for melting non-ferrous metal;
an element configured to transfer molten metal;
a cement plant furnace;
an ore reduction furnace;
an incinerator;
a hazardous waste treatment furnace;
a gasifier;
a reformer;
a ceramic firing furnace;
a carbon black reactor;
a holding tank intended to contain a molten product at a temperature in excess of 250 °C;
an aluminum electrolysis cell;
an impeller combustion chamber;
a boiler.

3. The process as claimed in claim 1, including, after step b), a step 5) of sintering the repair product introduced into the mold in step b), the sintered repair product obtained consisting of a plurality of constituents, the mass content of any constituent of the sintered repair product present in a mass content greater than 5%
differing by less than 20% from the mass content of said constituent in said ceramic matrix composite, and/or
differing by less than 20% from the mass content of said constituent in a region of the industrial facility delimiting the region to be repaired.

4. The process as claimed in claim 1, in which at least one element of said formwork has the shape of a part of the industrial facility which was protruding before said part disappeared as a result of wear.

5. The process as claimed in claim 1, in which manufacture of the formwork includes taking an imprint on an at least partial replica of said industrial facility as it was before the wear which led to the generation of the region to be repaired.

6. The process as claimed in claim 1, in which the formwork is abandoned in the region to be repaired after said repair.

7. The process as claimed in claim 1, in which the inner formwork is made entirely of a ceramic matrix composite.

8. The process as claimed in claim 1, in which at least one element of the formwork made of a ceramic matrix composite includes through holes and/or recesses arranged so as to be filled with the repair product during step b).

9. The process as claimed in claim 1, in which the formwork includes
formwork elements partially delimiting the region to be repaired, and
optionally, accessories for holding said formwork elements in a working position, said accessories being made of a ceramic matrix composite, identical to or different from the ceramic matrix composite of the formwork elements.

10. The process as claimed in claim 9, in which at least one formwork element has the shape of a flat or non-planar plate, the thickness of the plate being greater than 3 mm and less than 50 mm.

11. The process as claimed in claim 1, in which the mass of more than 50% by number of the formwork elements is greater than 3 kg and less than 50 kg, and/or in which the largest dimension of more than 30% by number of the formwork elements is greater than 400 mm and less than 1600 mm.

12. The process as claimed in claim 1, in which
the ceramic matrix composite of at least a part of the formwork and/or
when the formwork includes accessories for holding said formwork elements in a working position of a ceramic matrix composite, the ceramic matrix composite of at least one accessory
is (are) sintered, and
has/have an open porosity greater than 15% and less than 50%, and
includes(s) more than 20% and less than 80% by volume of fibers, and and
includes(s) a matrix made up of more than 90% oxides and/or carbides and/or nitrides and/or oxynitride compound(s) of at least the elements Si, Al and N, as a mass percentage, and
has/have a bulk density greater than 1.0 g/cm³ and less than 2 g/cm³.

13. The process as claimed in claim 1, said process including the following steps:
3) reducing the temperature in said industrial facility to a temperature above 250 °C;
4) performing steps a) and b);
5) increasing and maintaining the temperature of the industrial facility between 400 °C and 1400 °C so as to sinter the repair product;
6) raising the temperature of said industrial facility to its operating temperature.

14. The process as claimed in claim 1, the industrial facility including a chamber containing a fluid product, said process including, prior to step a), the following step:
if the region to be repaired is, at least partially, delimited by a surface of the industrial facility in contact with said fluid product, at least partial emptying of said chamber so as to expose said region to be repaired;
and, after step b), the following step:
resumption of normal operation,
the temperature of the industrial facility being maintained in said region to be repaired throughout all the steps of the process.

15. The process as claimed in claim 1, the industrial facility including a chamber containing a fluid product, said process including, prior to step a), the following steps:
1) if the region to be repaired is, at least partially, delimited by a surface of the industrial facility in contact with said fluid product, at least partial emptying of said chamber, so as to expose said region to be repaired;
3) reducing the temperature in the region to be repaired to a temperature above 250 °C; and, after step b), the following steps:
5) increasing and maintaining the temperature of the region to be repaired between 1000 °C and 1400 °C so as to sinter the repair product;
6) resumption of normal operation of the industrial facility.

16. The process as claimed in claim 15, in which, in step 3), the temperature in the region to be repaired is reduced to a temperature above 900 °C and below 1500 °C.

17. The process as claimed in claim 14, including a step of rinsing the region to be repaired after exposure of the region to be repaired.

18. The process as claimed in claim 1, in which the region to be repaired is at least partly delimited
by a runner, or
by a side wall or a bottom wall of a tank intended to contain a molten product, said formwork including or consisting of an inner formwork installed inside said tank in step a).

19. The process as claimed in claim 18, in which the tank defines a closed chamber that is inaccessible to an operator.

20. The process as claimed in claim 19, in which the region to be repaired is at least partly delimited by a said side wall.
